(19) United States
(12) Patent Application Publication
(10) Pub. No.: US 2009/0058078 A1
(43) Pub. Date: Mar. 5, 2009

(54) SEALED DUCTWORK

(76) Inventor: Gary A. Knudson, Oak Creek, CO (US)

Correspondence Address: ANCEL W. LEWIS, JR., 425 WEST MULBERRY, SUITE 101, FORT COLLINS, CO, 80521, US

(21) Appl. No.: 12/201,136

(22) Filed: Aug. 29, 2008

Related U.S. Application Data
(60) Provisional application No. 60/969,734, filed on Sep. 4, 2007.

(51) Int. Cl. F16L 41/08

(52) U.S. Cl. 285/136.1

(57) ABSTRACT

A sealed ductwork system has sealed, roll formed connections that form longitudinal seams and end joints for duct sections. The connections have one part with an open receptacle and a spaced flange, and another part with a round nose and a spaced tail. The nose fits into the receptacle with an interference fit and the flange secures the tail. Rectangular duct sections have radiused corners to facilitate sealing of the connections around the corners. A bead of sealant can be applied into the receptacle to enhance sealing.

This application claims the benefit under 35 U.S.C. §119(e) of the U.S. provisional patent application No. 60/969,734 filed Sep. 4, 2007.

### TECHNICAL FIELD

The present invention relates to heating, air conditioning and ventilation, and more particularly to a snap together, sealed sheet metal ductwork system.

### BACKGROUND ART

In heating and air conditioning, air is generally distributed from a heated or cooled air source to locations throughout a structure by a series of light gauge metal sectional ducts. The main plenum ducts used to distribute bulk air from the air source are typically rectangular in cross section. Air is distributed from main plenums through takeoffs to smaller rectangular ducts, or round or oval pipes. Air is ultimately distributed to registers and into open areas in the structure.

Structures using a forced air system, such as homes, office buildings, commercial structures or industrial structures, have a ductwork system with varying sizes, shapes and gauges of ducts. The ducts are usually manufactured in four to ten foot sections, are shipped knocked-down for ease of transportation and snapped together at the jobsite. For example, rectangular sections each include a pair of L shaped portions. The L shaped sections can be efficiently stacked for shipping.

The duct sections are typically crimped on one end to allow the crimped end to slip inside the end of the next section, forming a mechanical end joint. These end joints and the longitudinal seams where the knocked-down duct sections snap together both allow significant loss of conditioned air. Typically the air loss is in the range of 20%. This air loss results in inefficiency and energy waste.

One known method for sealing duct section seams and joints includes applying mastic and covering the mastic with specialized tape. This method is labor intensive and adds considerable cost to the installation of ductwork. U.S. Pat. No. 1,839,674 to Hayman discloses a longitudinal interlocking stovepipe seam. U.S. Pat. No. 2,323,256 to Thompson discloses a tapering longitudinal stovepipe seams.

Another known method for sealing ductwork includes installing separate connectors between duct sections or along duct section seams. U.S. Pat. No. 431,697 to Kummel discloses a ductwork system with seam connectors and joint connectors. U.S. Pat. No. 1,935,690 to Zack, U.S. Pat. No. 3,246,918 to Burghart, U.S. Pat. No. 3,512,805 to Glatz, U.S. Pat. No. 3,836,181 to Kelver, U.S. Pat. No. 6,203,074 to Daniel and U.S. Pat. No. 7,018,127 to Walsh et al. disclose end joint duct section connectors. Separate seam connectors and joint connectors increase ductwork cost and installation labor. Sealing the sharp corners of rectangular ductwork without separate connectors, or mastic and tape is difficult.

### Disclosure of the Invention

A sealed ductwork system includes a plurality of substantially rectangular duct sections with radiused corners and a plurality of sealed connections. The sealed connections form both the longitudinal seams in the duct sections and the end joints that connect the duct sections together. Each connection has a female first connection portion and a male second connection portion. The first connection portion includes a rounded receptacle, a spaced, rounded flange and a bead of sealant inside the receptacle. The second connection portion includes a rounded nose and a spaced, rounded tail. The nose wedges into the receptacle and the against the sealant, and the flange receives and secures the tail.

### BRIEF DESCRIPTION OF THE DRAWINGS

Details of this invention are described in connection with the accompanying drawings that bear similar reference numerals in which:

FIG. 1 is a perspective view of a sealed ductwork system embodying features of the present invention.

FIG. 2 is an exploded view of the system of FIG. 1.

FIG. 3 is a partial sectional view taken along line 3-3 of FIG. 1, of a partially completed sealed connection of the system of FIG. 1.

FIG. 4 is a partial sectional view taken along line 3-3 of FIG. 1, of the completed sealed connection of the system of FIG. 1.

FIG. 5 is an end elevation view of the first portion of the connection of FIG. 3.

FIG. 6 is an end elevation view of the second portion of the connection of FIG. 3.

### DETAILED DESCRIPTION OF THE INVENTION

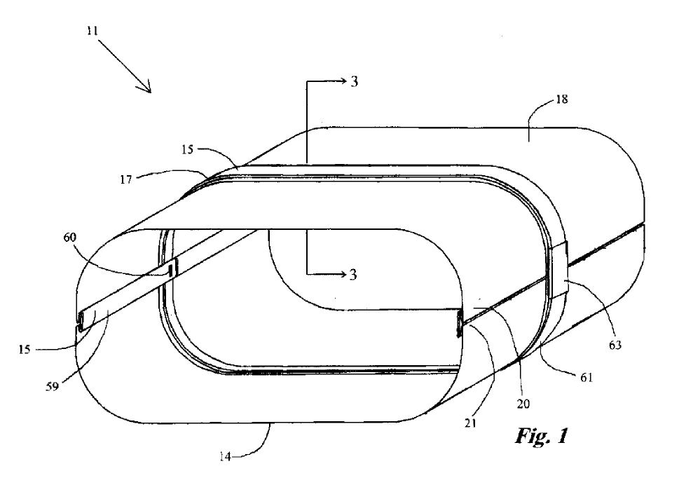

Referring now to FIGS. 1 and 2, a sealed ductwork system 11 shown has two duct sections 14 and a plurality of sealed connections 15. The duct sections 14 have a substantially rectangular cross section with radiused corners 17 and are preferably formed from sheet metal. Each duct section 14 shown has two duct portions 18, with one duct portion 18 making up the upper half of the duct section 14 and the other duct portion 18 making up the lower half of the duct section 14. The duct portions 18, before assembly into duct sections 14, can be stacked for efficient shipping and handling.

Describing the specific embodiments herein chosen for illustrating the invention, certain terminology is used which will be recognized as being employed for convenience and having no limiting significance. For example, the terms “right”, “left”, “up”, and “down”, refer to the illustrated embodiment of the connection as shown in the drawings. The terms “inward” and “outward” refer to directions toward and away from the geometric center of the system. Further, all of the terminology above-defined includes derivatives of the word specifically mentioned and words of similar import.

Each duct portion 18 has a first side 20, a spaced second side 21, and spaced first and second ends 22 and 23 extending between the first and second sides 20 and 21. A female first connection portion 25 is formed in the first side 20 of each duct portion 18 and a male second connection portion 26 is formed in the second side 21 of each duct portion 18.

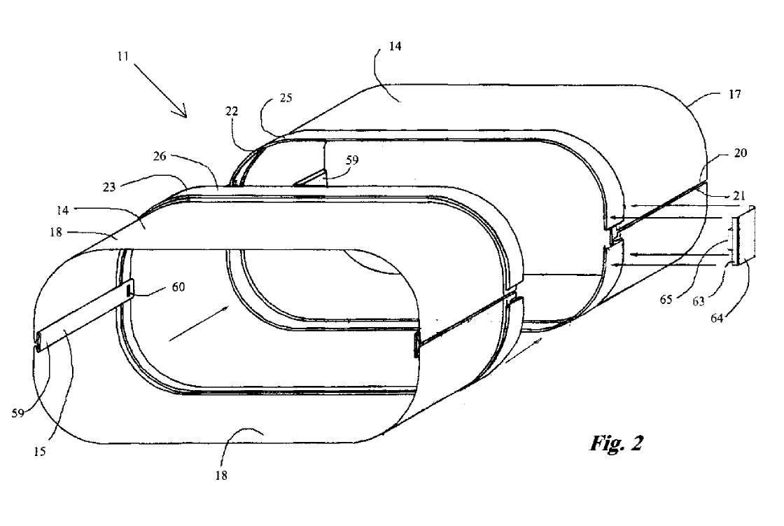

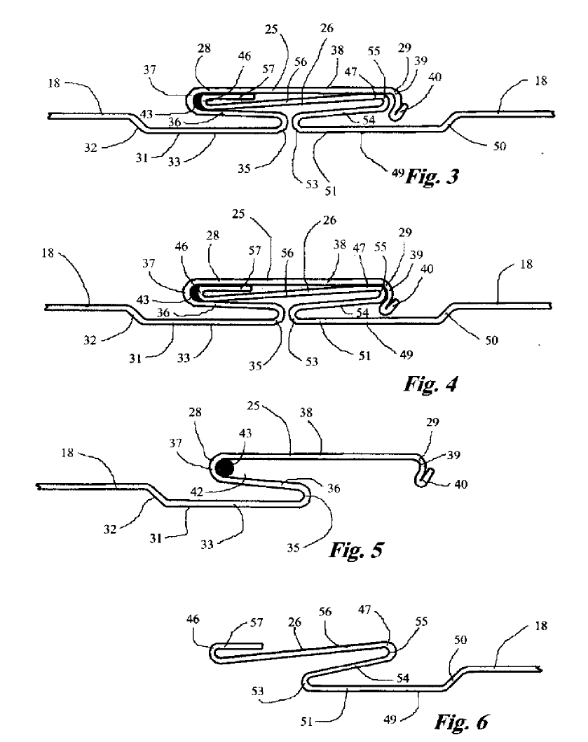

As shown in FIGS. 3 to 6, a connection 15 includes a first connection portion 25 and a second connection portion 26. The first connection portion 25 includes an open receptacle 28 and a spaced, rounded flange 29. The first connection portion 25 shown connects to the duct portion 18 through a first offset portion 31. The first offset portion 31 has a first segment 32 that extends rightwardly and downwardly at an angle from the duct portion 18, and a second segment 33 that extends rightwardly from the first segment 32.

The first connection portion 25 has an open, curved first fold 35, generally straight first section 36, an open, curved first end 37, a generally straight second section 38, a curved second end 39 and a closed second fold 40. The first fold 35 connects to the right extent of the second segment 33 of the first offset portion 31 and curves counterclockwise around an angle of slightly less than 180 degrees. The first section 36 extends from the first fold 35 leftwardly and at a small angle upwardly. The first end 37 extends from the first section 36 and curves clockwise around an angle of slightly less than 180 degrees. The second section 38 extends rightwardly from the first end 37, beyond the first fold 35, parallel and spaced from the duct portion 18. The second end 39 extends from the second section 38 and curves clockwise around an angle of less than 180 degrees. The second fold 40 is folded counterclockwise against the second end 39.

The receptacle 28 is formed by the first end 37, the first section 36 and part of the second section 38 of the first connection portion 25. The receptacle 28 is generally a rightwardly opening U shape with slightly diverging legs formed by the first and second sections 36 and 38, and defines a cavity 42. A bead of sealant 43 is applied into the cavity 42 of receptacle 28 at first end 37. The flange 29 is formed by the second end 39 and the second fold 40 of the first connection portion 25.

The second connection portion 26 includes a rounded nose 46 and a spaced, rounded tail 47. The second connection portion 26 shown connects to the duct portion 18 through a second offset portion 49. The second offset portion 49 has a first segment 50 that extends leftwardly and downwardly at an angle from the duct portion 18, and a second segment 51 that extends leftwardly from the first segment 50.

The second connection portion 26 has an open, curved first fold 53, generally straight first section 54, an open, curved end 55, a generally straight second section 56, and a curved, open second fold 57. The first fold 53 connects to the left extent of the second segment 51 of the second offset portion 49 and curves clockwise around an angle of slightly less than 180 degrees. The first section 54 extends from the first fold 53 rightwardly and at a small angle upwardly. The end 55 extends from the first section 54 and curves counterclockwise around an angle of slightly less than 180 degrees. The second section 56 extends leftwardly from the end 55 beyond the first fold 53, at a small downward angle. The second fold 57 extends from the second section 56 and curves clockwise around an angle over 180 degrees.

The nose 46 is formed by the second fold 57. The nose 46 is sized slightly larger than the receptacle 28 of the first connection portion 25 so that when the nose 46 is inserted into the receptacle 28, the nose 46 wedges in, creating an interference fit to seal the connection 15. When the nose 46 is inserted into the receptacle 28, the nose 46 deforms the bead of sealant 43, enhancing the sealing of the connection 15.

The tail 47 is formed by the end 55. The tail 47 is spaced a selected distance from the nose 46 such that when the nose 46 is inserted into the receptacle 28 the tail 47 clears the flange 29. To assemble the connection 15, the nose 46 is inserted into the receptacle 28 and the tail 47 moved inside the flange 29, as shown in FIG. 3. The flange 29 is then pushed or formed against the tail 47, by hand crimping or roll forming, to secure the second connection portion 26 inside the first connection portion 25 and complete the sealed connection 15, as shown in FIG. 4.

Referring again to FIGS. 1 and 2, the first and second connection portions 25 and 26 along the first and second sides 20 and 21 of the duct portions 18 form sealed longitudinal seams 59, joining two duct portions 18 into a duct section 14. The first and second connection portions 25 and 26 shown that form the longitudinal seams 59 are located internally in the duct section 14. An end crimp 60 seals the end of each longitudinal seam 59. Generally, the flanges 29 on the longitudinal seams 59 are roll formed, but the flanges 29 on the longitudinal seams 59 can also be hand crimped.

A first connection portion 25 is formed in the first end 22 of each duct portion 18 and a second connection portion 26 is formed in the second end 23 of each duct portion 18. The sealed end joint 61 that joins two duct sections 14 includes the first connection portions 25 on the first ends 22 of the duct portions 18 on one duct section 14 joined to the second connection portions 26 on the second ends 23 of the duct portions 18 on the other duct section 14. The first and second connection portions 25 and 26 shown that form the end joint 61 are external to the duct sections 14. Generally, the flanges 29 on the end joints 61 are hand crimped, but the flanges 29 on the end joints 61 can also be roll formed.

A sealant clip 63 includes a channel shaped clip portion 64 and a sealant block 65. The clip portion 64 is sized and shaped to clip over and extend between the end joints 61 of the shown upper and lower duct portions 18. The longitudinal seams 59 of the duct sections 14 and the end joints 61 that join adjacent duct sections 14 intersect transversely. The sealant block 65 mounts in the clip portion 64 and is made of a compressible sealant material. The sealant block 65 is generally square, and sized and shaped to fit between and seal the ends of the longitudinal seams 59 and the end joints 61 at the intersection of the longitudinal seams 59 and the end joints 61.

The radiused corners 17 of the duct sections 14 provide cleaner air flow and facilitate elbow-style bends. The radiused corners 17 also allow continuous seaming and therefore sealing of the end joints 61, and provide greater access around the duct sections 14. The first and second offset portions 31 and 49 that connect the first and second connection portions 25 and 26 to the duct portion 18 maintain seam integrity in the end joints 61 around the curvature of the corners 17. The first and second offset portions 31 and 49 are not needed to connect the first and second connection portions 25 and 26 to the duct portion 18 for the longitudinal seams 59.

The connections 15 of the ductwork system 11 seal the longitudinal seams 59 and end joints 61 without mastic and tape, or separate connectors. The radiused corners 17 facilitate corner sealing of the end joints 61. The connections 15 may be formed with or without the bead of sealant 43. The duct sections 14 can be round, oval or other shapes. The duct sections 14 can have one duct portion 18 with one longitudinal seam 59.

Although the present invention has been described with a certain degree of particularity, it is understood that the present disclosure has been made by way of example and that changes in details of structure may be made without departing from the spirit thereof.

What is claimed is:

1. A sealed ductwork system comprising:
at least two duct sections, and
a sealed connection connecting an adjacent pair of said duct sections, said connection having a first connection portion attached to one of said duct sections of said pair and a second connection portion attached to the other said duct section of said pair, said first connection portion including a rounded receptacle having a cavity and a spaced flange, and said second connection portion including a rounded nose and a spaced tail, said nose being sized slightly larger than said receptacle,
whereby, when said nose is inserted into said receptacle, said nose creates an interference fit in said receptacle to form said sealed connection.

2. The system as set forth in claim 1 wherein said sealed connection includes a bead of sealant in said cavity sized to deform and seal when said nose is inserted into said receptacle.

3. The system as set forth in claim 1 including a first offset portion that attaches said first connection portion to one of said duct sections and a second offset portion that attaches said second connection portion to the other of said duct sections.

4. The system as set forth in claim 1 wherein said tail fits into said flange and said flange bears against said tail to secure said second connection portion inside said first connection portion.

5. The system as set forth in claim 1 wherein said flange is one of roll formed and hand crimped against said tail to secure said second connection portion inside said first connection portion.

6. The system as set forth in claim 1 wherein said duct sections have a substantially rectangular cross-section with radiused corners.

7. The system as set forth in claim 1 wherein:
said duct sections each have at least one duct portion with each said duct portion having a first side and a spaced second side, and
said duct sections have a said sealed connection for each said duct portion connecting a said first side and a said second side and defining a longitudinal seam,
whereby said duct sections can be shipped and stored as knocked-down duct portions and then assembled into sealed duct sections.

8. The system as set forth in claim 7 wherein: said sealed connection between said duct sections defines an end joint,
said end joints are external to said duct sections, and
said longitudinal seams are internal to said duct sections.

9. The system as set forth in claim 8 including a sealant clip with a sealant block sized and shaped to seal said duct sections at each intersection of said end joints and said longitudinal seams.

10. A sealed ductwork system comprising:
a plurality of duct sections having a substantially rectangular cross-section with radiused corners, said duct sections each having at least one duct portion with each said duct portion having a first side, a spaced second side, a first end and a spaced second end,
a plurality of sealed connections with one said connection connecting adjacent first and second ends of said duct portions and defining a sealed end joint between said duct sections, and one said connection connecting adjacent first and second sides of said duct portions and defining a longitudinal seam, each said connection having a first connection portion attached to one of said first side and first end, and a second connection portion attached to one of said second side and second end, said first connection portion including a rounded receptacle that defines a cavity, a spaced, rounded flange, and a bead of sealant in said cavity, and said second connection portion including a rounded nose and a spaced, rounded tail, said nose being sized slightly larger than said receptacle, said tail being sized to fit into said flange, said flange being formed against said tail to secure said second connection portion inside said first connection portions, and said end joint protruding outwardly and said longitudinal seam protruding inwardly, and
a sealant clip with a sealant block sized and shaped to seal said duct sections at each intersection of said end joints and said longitudinal seams,
whereby, when said nose is inserted into said receptacle, said nose creates an interference fit in said receptacle and deforms said bead of sealant, and seals said connection.

11. A duct section for a sealed ductwork system comprising:
at least one duct portion having a first side, a spaced second side, a first end and a spaced second end,
a first connection portion attached to said first end of each said duct portion, said first connection portion including a rounded receptacle that defines a cavity, and a spaced, rounded flange, and
a second connection portion attached to each said second end, said second connection portion including a rounded nose and a spaced, rounded tail, said nose being sized slightly larger than said receptacle, said tail being sized to fit into said flange,
whereby, when said nose on said second end is inserted into a said receptacle on a first end of another said duct portion, said nose creates an interference fit in said receptacle and forms sealed end joint, and when said receptacle on said first end receives a said nose a second end of another said duct portion, said nose creates an interference fit in said receptacle and forms sealed end joint.

12. The duct section as set forth in claim 11 including a said first connection portion attached to each said first side and a said second connection portion attached to each said second side,
whereby said first and second connection portions on said first and second sides form sealed longitudinal seams.

13. The duct section as set forth in claim 11 wherein said first and second connection portions on said first and second ends protrude outwardly and said first and second connection portions on said first and second sides protrude inwardly.

14. The duct section as set forth in claim 11 wherein said first connection portion includes a bead of sealant in said cavity sized to deform when said nose is inserted into said receptacle.

15. The duct section as set forth in claim 11 including a first offset portion that attaches said first connection portion to said first end and a second offset portion that attaches said second connection portion to second end.

16. The duct section as set forth in claim 11 wherein said at least one duct portion, when assembled, has a substantially rectangular cross-section with radiused corners.

17. The duct section as set forth in claim 11 including a first offset portion that attaches said first connection portion to said first end and a second offset portion that attaches said second connection portion to said second end.

18. The duct section as set forth in claim 11 wherein said flange is one of roll formed and hand crimped against said tail to secure said second connection portion inside said first connection portion.

19. A sealed connection for ductwork having at least one duct section with at least one duct portion, comprising:
a first connection portion connected to a said duct portion and including a rounded receptacle that defines a cavity, and a spaced flange, and
a second connection portion connected to a said duct portion and including a rounded nose and a spaced tail, said nose being sized slightly larger than said receptacle, said tail being sized to fit into said flange,
whereby when said nose is inserted into said receptacle, said nose creates an interference fit in said receptacle, and seals between said first and second connection portions.

20. The sealed connection as set forth in claim 19 wherein said first and second connection portions form one of an end joint and a longitudinal seam in said ductwork.

21. The sealed connection as set forth in claim 19 wherein said first connection portion includes a bead of sealant in said cavity.

22. The sealed connection as set forth in claim 19 wherein said tail fits into said flange and said flange is formed against said tail to secure said second connection portion inside said first connection portion.

23. The sealed connection as set forth in claim 19 wherein said flange is one of roll formed and hand crimped against said tail to secure said second connection portion inside said first connection portion.

24. The sealed connection as set forth in claim 19 wherein:
said first connection portion includes an open first fold, a substantially straight first section extending from the first fold, a first end that extends from the first section and curves in a direction opposite the curve of said first fold, a substantially straight second section extending from said first end and spaced from said first section, a second end that extends from said second section and curves in the same direction as said first end, and a closed second fold that folds in the direction opposite the curve of said second end, with said first and second sections diverging slightly from said first end, said first section, said first end and said second section defining said receptacle, and said second end defining said flange, and
said second connection includes an open first fold, a substantially straight first section extending from said first fold, an open end that extends from said first section and curves in a direction opposite the curve of said first fold, a substantially straight second section extending from said end, and an open second fold that extends from said second section and curves in a direction opposite the curve of said end, with said second fold defining said nose and said end defining said tail.
